(19) United States
(12) Patent Application Publication
(10) Pub. No.: US 2011/0279398 A1
(43) Pub. Date: Nov. 17, 2011

(54) TOUCH SCREEN ELECTRODE ENHANCEMENTS

(76) Inventor: Harald PHILIPP, Hamble (GB)

(21) Appl. No.: 12/778,693

(22) Filed: May 12, 2010

(51) Int. Cl. G06F 3/045

(52) U.S. Cl. 345/174

(57) ABSTRACT

Darkening layers and/or passivation layers are provided on electrodes of panels for touch sensitive screens. Darkening, for example, reduces reflections of ambient light that might otherwise increase electrode visibility. Passivation reduces performance degradation due to electrode oxidation. A darkening layer may also serve as a passivation layer.

### BACKGROUND

A touch position sensor is a device that can detect the presence and location of a touch, by a finger or by an object, such as a stylus, for example, within a display area of the position sensor display screen. In a touch sensitive display application, the position sensor enables direct interaction with what is displayed on the screen, rather than indirect action via a mouse, keyboard or touchpad. Position sensors can be attached to or provided as part of computers, personal digital assistants, satellite navigation devices, mobile telephones, portable media players, portable game consoles, public information kiosks, and point of sale systems, etc. Position sensors have also been used as control panels on various appliances.

There are a number of different types of position sensors/touch screens, such as resistive touch screens, surface acoustic wave touch screens, capacitive touch screens, etc. A capacitive touch screen, for example, may include an insulator and one or more layers of a transparent conductor forming a particular capacitive electrode pattern. When an object, such as a finger or a stylus, touches (comes in contact with or is provided in close proximity to) the surface of the screen there is a change in capacitance. This change in capacitance is processed by a controller to determine the position of the touch.

In a mutual capacitance configuration, for example, an array of conductive drive electrodes or lines and conductive sense electrodes or lines can be used to form a touch screen having a plurality of capacitive nodes. A node is formed at each intersection of drive and sense electrodes. Although referred to as an intersection, the electrodes cross but do not make electrical contact. Instead, the sense electrodes are capacitively coupled with the drive electrodes at the intersection nodes. A pulsed or alternating voltage applied on the drive electrode will therefore induce a charge on the sense electrode, the amount of induced charge being susceptible to external influence, such as from the proximity of a nearby finger. When an object touches (contacts or comes in close proximity to) the surface of the screen, the capacitance change at every individual node on the grid can be measured to determine the location or position of the touch.

While clear conductors such as ITO are commonly used for electrodes, in some cases opaque metal conductors are used to reduce cost and decrease electrode resistance as compared with ITO. Some screens may be made of conductive mesh which may be of copper, silver other conductive materials. However, even when metal electrodes are made very thin such as less than 10 μm in width, the electrodes can still be visible to the naked eye by means of reflected light. Since most metals reflect light, the reflections from the electrodes can be easily observed under certain lighting and display state conditions. In such situations it is possible to reduce the reflectivity of the electrodes to make them less visible.

### SUMMARY

Darkening allows electrodes of touch sensitive screens to be less visible to the naked eye by darkening the conductors so that they are less able to reflect light, even when subject to a concentrated light source. Passivation layers on touch screen electrodes reduce oxidation that may otherwise degrade performance by causing increases in resistance of the conductors when exposed to air for prolonged periods. A darkening layer may also serve as a passivation layer.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1 illustrates a cross-sectional view of a touch sensitive screen;

FIG. 2 illustrates an exemplary conductor of a touch sensitive screen provided with a darkening layer;

FIG. 3 illustrates another exemplary conductor of an example of a touch sensitive screen provided with a darkening layer;

FIG. 4 illustrates a cross-sectional view of an example of a touch sensitive screen provided with darkening layers on each electrode;

FIG. 5 illustrates a cross-sectional view of a touch sensitive screen provided with darkening layers;

FIG. 6 illustrates a cross-sectional view of another exemplary touch sensitive screen provided with darkening layers;

FIG. 7 illustrates an apparatus for printing a darkening layer; and

FIGS. 8A-B illustrate a cross-sectional view of touch sensitive screens provided with a passivation layer and a darkening layer.

### DETAILED DESCRIPTION

In the following detailed description, numerous specific details are set forth by way of examples in order to illustrate the relevant teachings. In order to avoid unnecessarily obscuring aspects of the present teachings, those methods, procedures, components, and/or circuitry that are well-known to one of ordinary skill in the art have been described at a relatively high-level.

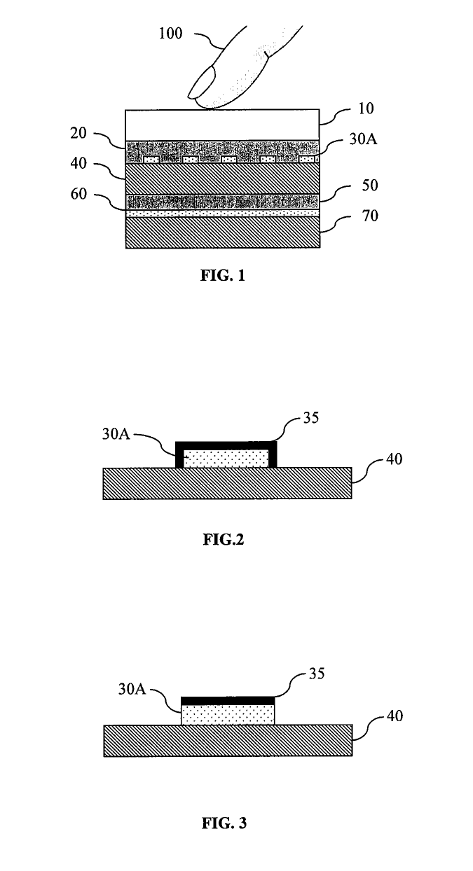

Reference now is made in detail to the examples illustrated in the accompanying figures and discussed below. FIG. 1 illustrates a side view of a touch sensitive screen. The touch sensitive screen of FIG. 1 is made up of a transparent panel 10, a first adhesive layer 20, a light transmissive conductive electrode layer 30, a first insulating substrate 40, a second adhesive layer 50, a second light transmissive conductive electrode layer 60, and a second insulating substrate 70.

A first conductive electrode layer 30 includes a plurality of first electrode strips 30A. A second conductive electrode layer 60 includes a plurality of second electrode strips 60A. A plurality of nodes are formed at the intersections of the first electrode strips 30A and the second electrode strips 60A. The electrode strips can be configured to form any particular pattern as desired. In FIG. 1, the second electrode strips are arranged perpendicular to the first electrode strips 30A such that only the side of one second electrode strip is visible in the side view. If the screen were rotated by 90°, the ends of the second electrode strips 60A would appear as the first electrode strips 30A.

The transparent panel 10 is made of a resilient, transparent material suitable for repeated touching. Examples of the transparent material include glass, Polycarbonate or PMMA (poly(methyl methacrylate)). The first and second adhesive layers 20, 50 are made of any optically clear adhesive suitable for use in a touch panel. The first and second conductive electrodes 30A, 60A are made of a conductive material, such as fine line conductive materials. Examples of fine line conductive materials include copper, conductive silk ink, silver or any other conductive material deposited to a suitably narrow width. In some examples, the first and second substrates 40, 70 are transparent materials, such as PET (polyethylene terephthalate), Polycarbonate, or glass.

In some examples, the first and second conductive electrode layers 30, 60 have a width of less than 100 μm. In other examples, the first and second conductive electrode layers 30, 60 have a width of 10 μm or less. In yet other examples, the first and second conductive electrode layers 30, 60 have a width of 5 μm or less. In certain examples, the first and second conductive electrode layers 30, 60 have a width which is substantially invisible to the human eye.

In some examples, the height of the first and second conductive electrode layers is less than 5 μm. In other examples the height of the first and second conductive electrode layers is less than 3 μm. In yet other examples, the height of the first and second conductive electrode layers is less than 2 μm.

In an application with a display, the touch screen of FIG. 1 would be mounted over the exterior of the display device, for example, with the substrate 70 adjacent to the display device (not shown). By way of example, in the illustrated orientation, the substrate 70 would be on top of the output surface of the display device. Elements of the layer stack in aggregate are substantially transparent. Light produced or reflected from the display device, representing displayed information, passes through the elements of the layer stack (upward in the exemplary orientation) for observation of the information by a user. The user may touch the panel 10, as shown at 100, to provide input such as to select from the information shown on the display.

However, since the elements of the layer stack are substantially transparent, ambient light also enters the screen from above. In the orientation illustrated in FIG. 1, ambient light would enter the screen from above through the transparent panel 10. Materials used to form the electrodes in layers 30 and 60 are reflective.

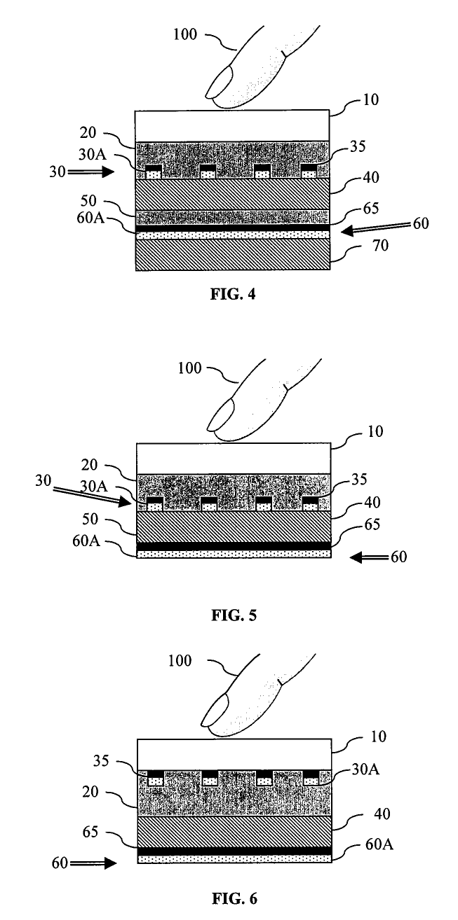

In order to lessen the amount of light reflecting from the conductive electrode layers which might otherwise increase visibility of the electrodes to the user, a darkening layer is applied to either one or both of the first and second conductive electrode layers 30, 60 on the side facing the user. FIGS. 2 and 3 illustrate a first conductive electrode 30A of a touch sensitive screen provided with a darkening layer 35. In other examples, the second conductive electrode 60A is also provided with a darkening layer 65 as shown in FIG. 4. FIG. 2 illustrates a darkening layer 35 surrounding the conductive electrode layer 30A on three sides, such that every surface of the conductive electrode which is not in contact with the substrate 40 is covered with the darkening layer 35. With the arrangement illustrated in FIG. 2, reflectivity of the conductive electrode 30A, particularly with respect to ambient light entering the screen through panel 10 is reduced, regardless of the angle of the incident light. FIG. 3 illustrates the darkening layer being provided on the top surface of the conductive electrode layer (the surface nearest the touch 100), which is potentially simpler to fabricate with some processes than the example shown in FIG. 2. The example in FIG. 3 is sufficient in cases where the electrode metal layer 30A is very thin relative to its width, such that the side walls do not provide a large enough surface by which light can be reflected to be visible.

FIG. 4 illustrates a side view of a touch sensitive screen provided with darkening layers on the various electrodes. Although the darkening layers 35, 65 are illustrated as only covering the top surface of the conductive electrodes 30A, 60A of layers 30, 60 respectively, in other examples a darkening layer 35 covers every surface of each electrode 30A, 60A of the conductive electrode layers 30, 60, which are not in contact with the substrates 40, 70 illustrated in FIG. 2

FIGS. 5 and 6 illustrate other exemplary touch sensitive screens provided with darkening layers. As illustrated in FIG. 5 the second conductive electrode layer 60 is provided onto the first substrate 40. Therefore, the second substrate 70 is not required. In this arrangement, the darkening layer 65 is provided between the substrate 40 and the second conductive electrode layer 60, on the surface nearest the touch 100.

In another example, the electrode is applied to the substrate 40 by electroless plating. In one exemplary method not described in a figure, a catalytic ink is coated onto the substrate 40 and then exposed to UV light through a photomask. The exposed ink layer is then washed in a solution to remove the unexposed ink. The remaining ink pattern on the substrate is then immersed in a copper solution (or any other suitable metal-containing bath) to coat the ink with a layer of copper or other metal, thereby creating the electrode. Since the ink can be dark, the ink layer underlying the electrode serves as a darkening layer 65. An example of such a catalytic ink application and plating process is available from Conductive Inkjet Technology Ltd. (Cambridge, UK).

As illustrated in FIG. 6 the first conductive electrodes 30A are provided on the panel 10 via a darkening layer 35 arranged in between the panel 10 and the first conductive electrodes 30A. In addition, the second conductive electrode layer 60 is provided on the substrate 40, although a second substrate 70 could be provided as shown in the example of FIG. 4. As with FIG. 5, the darkening layer 65 in FIG. 6 is provided between the substrate 40 and the second conductive electrode layer 60, on the surface nearest the touch 100. However, this example does not provide an adhesive layer 20 in between the panel 10 and the first conductive layer 30 or an adhesive layer 50 between the insulating substrate 40 and the second conductive layer 60. As a result, this example may use fewer materials and process steps in the production of the touch screen resulting in a thinner and less expensive panel.

In order to apply darkening layers 35, 65 to electrodes of the first and second conductive electrode layers 30, 60, several different processes can be used.

In one example, a darkening layer 35, 65 is applied to the first and second conductive electrode layers 30, 60 using a chemical process. In one example, first and second conductive electrode layers are dipped in a chemical solution or exposed to a gas, which alters the composition of the first and second conductive electrode layers to a depth of a few nanometers creating a darkening layer 35, 65 on the first and second conductive electrode layers. The depth of the darkening layer depends on the type of material of the first and second conductive electrode layers and the solution/gas applied. However, the darkening layer should be kept as thin as possible so that the layer does not degrade the conductivity of the first and second conductive electrode layers, which would reduce the electrical performance of the screen. In one example, the darkening layer is no more than 10% of the thickness of the respective electrodes of the first and second conductive electrode layers 30, 60. In one example, the darkening layer 35, 65 is a copper oxide, a copper sulfide compound, or the like. When the darkening layer is copper oxide or copper sulfide compound, the darkening layer is applied to all of the surfaces of the first and second conductive electrode layers 30, 60 that are exposed to ambient light and which are located over the display.

In another example, a darkening layer 35, 65 is applied to the first and second conductive electrode layers 30, 60 using a plating process. In this example, the conductive electrode layers are applied electrochemically (or electroless) by immersion into a solution which deposits a thin layer of darkening material, such as titanium, tungsten, etc. on the surface of the first and second conductive electrode layers.

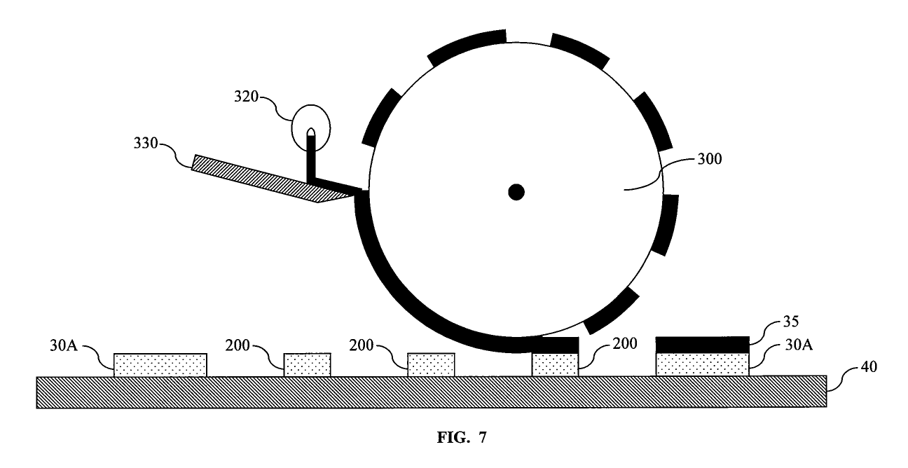

In another example, a darkening layer 35, 65 is applied to the first and second conductive electrode layers layer 30, 60 using a printing process. In this example, a dark ink is printed onto the surface of the first and second conductive electrodes 30A, 60A facing the ambient light (the surface nearest the touch 100 on the panel 10 as shown in FIGS. 1 and 4-6). The darkening layer 35, 65 is only applied to these surfaces of the first and second conductive electrodes 30A, 60A using the printing process, such as illustrated in FIG. 7. As shown in FIG. 7, a roller 300 applies a thin layer of darkening material 35 to the electrode 30A, 60A and the support 200. The darkening material layer on the roller is maintained at a constant thickness by use of a doctor blade 330. Darkening material is applied to the roller 300 via an applier 320. In one example, the darkening layer is no more than 20% of the thickness of the respective electrodes of the first and second conductive electrode layers layer 30, 60.

Depending on the pattern formed by the first and second conductive electrode layers 30, 60, there may be relatively large areas of the touch screen which do not contain any first and second electrodes 30A or 60A. In this instance it may be necessary to provide supports 200, such as illustrated in FIG. 7, which will support the roller 300 during the printing process, to prevent the printing of ink into empty regions of substrate 40. These mechanical supports 200 can then be removed following printing, or may be so small and infrequently spaced as to be practically invisible and therefore may be left in place following the printing step. For example, if the supports 200 are 10 μm wide dots or squares, widely spaced apart for example by 200 μm, then they will remain invisible and will not need to be removed after the printing step.

As many metals such as copper are prone to oxidize in air thereby degrading their performance over time, it is desirable to protect the metal from oxidation via a coating. The ink used to darken the metal intrinsically will provide protection from corrosion, but this ability can be improved by the use of special formulations of ink, for example by adding an anti-oxidant additive to the ink, or by adding a sacrificial oxidizing additive such as elemental iron to the ink In some cases it may be necessary to print or otherwise deposit a special coating on the metal traces prior to printing the darkening layer but a preferred embodiment incorporates the ability to protect against corrosion in the ink itself as discussed above.

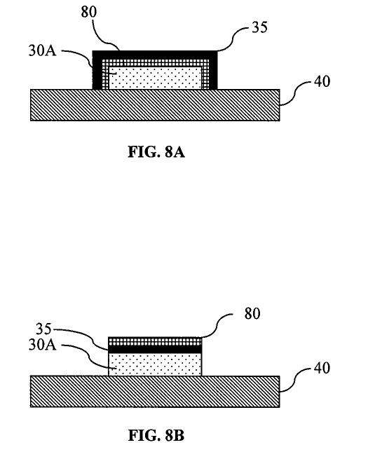

FIGS. 8A and 8B illustrate a first conductive electrode 30A of a touch sensitive screen provided with a passivation layer 80 and a darkening layer 35. However, the second conductive electrode 60 may also be provided with a passivation layer. FIG. 8A illustrates the passivation layer 80 substantially surrounding the conductive electrode 30A, such that every surface of the conductive electrode layer which is not in contact with the substrate 40 is covered with the passivation layer 80. The passivation layer is then coated with a darkening layer 35. FIG. 8B illustrates the passivation layer being provided on the top surface of the conductive electrode 30A (the surface nearest the touch 100). A passivation layer 80 is then applied on the top surface of the darkening layer 35

In order to apply passivation layers 80 to the first and second conductive electrode layers 30, 60 several different processes can be used. In an example, it is possible to apply a passivation layer 80 to the first and second conductive electrode layers 30, 60 using a chemical process. In one example, the first and second conductive electrode layers are dipped in a chemical solution such as sulfurated potash, or exposed to a suitable gas, which alters the composition of the first and second conductive electrode layers to a depth of a few atoms creating passivation layers 80 on the first and second conductive electrode layers. The passivation layer is a very thin layer of chemically converted material, such as metal oxide or sulfide etc., which stabilize the performance of the first and second conductive electrode layers. The depth of the passivation layer depends on the material of the first and second conductive electrode layers and the solution/gas applied, its dilution or density and the temperature and duration of exposure. However, the passivation layer should be kept as thin as possible so that the layer does not substantially degrade the conductivity of the first and second conductive electrode layers, or reduce the performance of the screen, yet still preventing uncontrolled oxidation and corrosion of the first and second conductive electrode layers. The treatments applied should not attack the substrate material in order to maintain optical clarity.

For example, some types of oxides may be converted on the surfaces of first and second conductive electrode layers to materials which are barriers to further oxidation, whereas naturally occurring oxides from atmospheric exposure may not provide such a barrier. In one example, the passivation layer is no more than 10% of the thickness of the respective electrodes of the first and second conductive electrode layers 30, 60. In this example, the darkening layer is applied to all of the exposed surfaces of the electrode layer at least within the viewing region of the display screen.

In another example, it is possible to apply a passivation layer 80 to the first and second conductive electrode layers 30, 60 using a plating process. In this example, the first and second conductive electrode layers are applied electrochemically (or electroless) by immersion into a solution which deposits a thin layer of protective metal over the first and second conductive electrode layers. In one example, a thin layer of protective metal, such as tin, nickel, gold etc. is plated over copper first and second conductive electrode layers. The passivation layer 80 should be kept as thin as possible so that the layer does not degrade the conductivity of the first and second conductive electrode layers, or reduce the performance of the screen. In one example, the passivation layer 80 is applied to a depth of 1 μm or less, and preferably 50 to 200 nm, which prevents oxidation or corrosion of the underlying first and second conductive electrode layers traces.

In another example, it is possible to apply a passivation layer 80 to the first and second conductive electrode layers 30, 60 using a coating process, which deposits a thin layer of non-conductive material such as a polymer over the first and second conductive electrode layers. The passivation layer 80 of non-conductive material dramatically reduces the rate of surface oxidation or corrosion. The coating can be applied by sheet-coating processes, or via a printing process, as is known in the art. The passivation layer 80 can be applied selectively on the first and second conductive electrode layers.

In the examples, when forming the darkening layers 35, 65 and the passivation layers 80, the darkening layers 35, 65 and the passivation layers 80 are formed on the first and second conductive electrode layers. If a non-conductive coating is being applied, for example, inadvertent application of the coating to connection points of the screen should be avoided. Alternatively, a very thin polymer can be used that is easily penetrated mechanically by a known connection method.

Although the darkening layers 35, 65 and the passivation layers 80 are described as separate layers it may be possible to form one layer on the first and second conductive electrode layers which performs the function of both darkening and passivation. For example, when using the chemical process a layer of copper oxide or copper sulfide may be formed, which not only prevents further oxidation of the copper by creating a barrier layer, but also darkens the copper in order to reduce unwanted reflections.

The touch sensitive screens described above can be attached to numerous electronic devices, such as computers, personal digital assistants, satellite navigation devices, mobile phones, portable media players, portable game consoles, public information kiosks, point of sale systems, etc.

Various modifications may be made to the examples and embodiments described in the foregoing, and any related teachings may be applied in numerous applications, only some of which have been described herein. It is intended by the following claims to claim any and all applications, modifications and variations that fall within the true scope of the present teachings.

What is claimed is:

1. A panel for a touch sensitive screen, comprising:
a transparent substrate;
a plurality of first conductive electrodes provided adjacent to the transparent substrate, at least one of the plurality of first conductive electrodes provided with a first darkening layer;
a plurality of second conductive electrodes, at least one of the plurality of second conductive electrodes provided with a second darkening layer, wherein a node is formed at intersections of the plurality of first conductive electrodes and the plurality of second conductive electrodes; and
a transparent insulating layer provided between the plurality of first conductive electrodes and the plurality of second conductive electrodes.

2. The panel of claim 1, wherein:
at least one of the plurality of first conductive electrodes is further provided with a first passivation layer, and
at least one of the plurality of second conductive electrodes is further provided with a second passivation layer.

3. The panel of claim 2, wherein:
the first passivation layer is provided between the first conductive electrode and the first darkening layer, and
the second passivation layer is provided between the second conductive electrode and the second darkening layer.

4. The panel of claim 1, wherein the darkening layers function as passivation layers.

5. The panel of claim 1, wherein the first and second conductive electrodes comprise fine line conductive materials.

6. A touch panel for a touch sensitive screen, comprising:
a first conductive electrode layer comprising a plurality of drive electrodes extending in a first direction;
a transparent insulating layer adjacent to the first electrodes;
a second conductive electrode layer, adjacent to the transparent insulating layer, comprising a plurality of sense electrodes extending in a second direction across the second insulating substrate to form capacitive couplings with the drive electrodes at nodes of intersection with electrodes of the first conductive electrode layer;
a transparent panel covering the second electrodes, for touch by an object and exposed to ambient light; and
a darkening layer on at least one surface exposed to ambient light through the transparent panel of at least one electrode of at least one of the first and second conductive electrode layers.

7. The panel of claim 6, wherein the darkening layers are formed only on surfaces of electrodes of the at least one of the first and second conductive electrode layers facing toward the transparent panel.

8. The panel of claim 6, wherein the darkening layers are formed on a plurality of surfaces of at least one electrode of the at least one of the first and second conductive electrode layers exposed to ambient light.

9. The panel of claim 6, wherein the darkening layers comprise darkening layers formed on at least one surface of at least one electrode of both of the first and second conductive electrode layers.

10. A panel for a touch sensitive screen, comprising:
a transparent insulating substrate;
a plurality of first conductive electrodes provided adjacent to the transparent insulating substrate, at least one of the plurality of first conductive electrodes having a first passivation layer;
a plurality of second conductive electrodes, at least one of the plurality of second conductive electrodes having a second passivation layer, wherein a node is formed at intersections of the plurality of first conductive electrodes and the plurality of second conductive electrodes; and
an transparent insulating layer provided between the plurality of first conductive electrodes and the plurality of second conductive electrodes.

11. A touch panel for a touch sensitive screen, comprising:
a first conductive electrode layer comprising a plurality of electrodes extending in a first direction;
a transparent insulating layer adjacent to the first electrodes;
a second conductive electrode layer, adjacent to the transparent insulating layer, comprising a plurality of electrodes extending in a second direction across the second insulating substrate to form capacitive couplings with the drive electrodes at nodes of intersection with all of the electrodes of the first conductive electrode layer;
a transparent panel covering the second electrodes, for being touched by an object and being exposed to ambient light; and
a passivation layer on at least one electrode of at least one of the first and second conductive electrode layers.

12. The panel of claim 1, wherein the first and second darkening layers are comprised of at least one material selected from the group of copper oxides and copper sulfides.

13. The panel of claim 6, wherein the darkening layer is comprised of at least one material selected from the group consisting of copper oxides and copper sulfides.

14. The panel of claim 1, wherein the first and second darkening layers are comprised of at least one material selected from the group consisting of titanium and tungsten.

15. The panel of claim 6, wherein the darkening layer is comprised of at least one material selected from the group consisting of titanium and tungsten.

16. The panel of claim 1, wherein the first and second darkening layers are comprised of at least one material selected from the group consisting of a pigment and an ink.

17. The panel of claim 6, wherein the darkening layer is comprised of at least one material selected from the group consisting of a pigment and an ink.

18. The panel of claim 10, wherein the first and second passivation layers are comprised of at least one selected material from the group consisting of copper oxides and copper sulfides.

19. The panel of claim 11, wherein the passivation layer is comprised of at least one material selected from the group consisting of copper oxides and copper sulfides.

20. The panel of claim 10, wherein the first and second passivation layers are comprised of at least one material selected from the group consisting of tin, nickel and gold.

21. The panel of claim 11, wherein the passivation layer is comprised of at least one material selected from the group consisting of tin, nickel and gold.

22. The panel of claim 10, wherein the first and second passivation layers are comprised of a polymer.

23. The panel of claim 11, wherein the passivation layer is comprised of a polymer.

24. The panel of claim 1, wherein the reflectivity to light of the first and second darkening layers is lower than the reflectivity to light of the material of the plurality of electrodes.

25. The panel of claim 6, wherein the reflectivity to light of the darkening layer is lower than the reflectivity to light of the material of the plurality of electrodes.

26. The panel of claim 2, wherein:
the first darkening layer is provided between the first conductive electrode and the first passivation layer, and
the second darkening layer is provided between the second conductive electrode and the second passivation layer.
